(19) United States
(12) Patent Application Publication
(10) Pub. No.: US 2023/0185621 A1
(43) Pub. Date: Jun. 15, 2023

(54) COMPUTER RESOURCE ALLOCATION SYSTEMS AND METHODS FOR OPTIMIZING COMPUTER IMPLEMENTED TASKS

(71) Applicant: Coupang Corp., Seoul (KR)

(72) Inventors: Rajorshi SEN, Seattle, WA (US); Beoumsuk KIM, Seoul (KR); Thimma Reddy KALVA, Seoul (KR); Hara Rama Krishna KETHA, Seoul (KR); Narendra PARIHAR, Seoul (KR)

(73) Assignee: Coupang Corp., Seoul (KR)

(21) Appl. No.: 17/552,020

(22) Filed: Dec. 15, 2021

(51) Int. Cl. G06F 9/50; G06F 21/31

(52) U.S. Cl. CPC G06F 9/5044; G06F 21/31; G06F 2209/5017; G06Q 30/0283

(57) ABSTRACT

A method for optimizing computer implemented tasks includes receiving, at a server from a user interface, a request to complete a computer implemented task. The method also includes determining whether to send the request to a first computer system or a second, cloud-based computer system, the determination based on (i) an estimated hardware requirement necessary to the complete the computer implemented task, (ii) a latency requirement of the computer implemented task, (iii) a hardware capacity of the first computer system, and (iv) an estimated financial cost of using the second, cloud-based computer system for the computer implemented task. The method further includes sending the request to complete the computer implemented task to either the first computer system or the second, cloud-based computer system based on the determination

### TECHNICAL FIELD

The present disclosure generally relates to computerized systems and methods for efficiently using computer system resources. In particular, embodiments of the present disclosure relate to inventive and unconventional systems for automatically allocating user-initiated, computer-implemented tasks (e.g., a machine-learning experiment) to a computer system that best makes use of limited computing resources advertising campaigns based on multiple artificial intelligence and/or machine learning models.

### BACKGROUND

Technology companies (e.g., E-commerce businesses) involved with processing large amounts of digital data, may utilize a variety of different types of computer systems to accomplish this processing. These computer systems may be owned and operated by the companies themselves on location (e.g., on-site managed blade servers). Alternatively, computer systems may be owned and operated by third party providers offering internet accessible computer resources (e.g., off-site cloud-based computer systems). Due to the sensitive nature of the digital data that is processed, both on-site and off-site computer systems typically require secure authentication of users to access the computer systems.

In this type of enterprise level data processing, one of the main issues is deciding where data should be processed. On-site computer systems offer an advantage of low operational latency (data does not have to travel far) with low operational costs (the hardware of on-site computer systems are sunk costs). Off-site cloud-based computer systems offer an advantage of providing computer resources that can be scaled on-demand via leveraging the massive storage and processing power capacity of large server farms and supercomputers.

There are deficiencies with the above-described computer systems used for data processing. Limitations of on-site computer systems include finite scalability, storage space, and processing speed. In particular, adding new hardware to the on-site computer systems can be expensive and time consuming (due to the time associated with identifying a need for additional computing resources, purchasing and receiving new hardware, and installing new hardware). Limitations of off-site cloud-based computer systems include latency (involved with sending data over large distances) and the high operating costs (incurred from renting access to resources from the third-party hosts). Additionally, it can be time consuming for users of these types of computer systems to have to authenticate themselves multiple times with every different computer system they may choose to use.

Therefore, there is a need for improved methods and systems for (i) deciding where data should be processed, and (ii) minimizing the time and effort associated with operating the computer systems that will process the data.

### SUMMARY

One aspect of the present disclosure is directed to a system. the system includes a processor. The processor is configured to receive, from a user interface, a request to complete a computer implemented task; determine whether to send the request to a first computer system or a second, cloud based computer system, the determination based on (i) an estimated hardware requirement necessary to the complete the computer implemented task, (ii) a latency requirement of the computer implemented task, (iii) a hardware capacity of the first computer system, and (iv) an estimated financial cost of using the second, cloud-based computer system for the computer implemented task; and end the request to complete the computer implemented task to either the first computer system or the second, cloud-based computer system based on the determination.

Another aspect of the present disclosure is directed to a method. The method includes receiving, at a server from a user interface, a request to complete a computer implemented task; determining whether to send the request to a first computer system or a second, cloud-based computer system, the determination based on (i) an estimated hardware requirement necessary to the complete the computer implemented task, (ii) a latency requirement of the computer implemented task, (iii) a hardware capacity of the first computer system, and (iv) an estimated financial cost of using the second, cloud-based computer system for the computer implemented task; and sending the request to complete the computer implemented task to either the first computer system or the second, cloud-based computer system based on the determination.

Yet another aspect of the present disclosure is directed to a system. The system includes a memory and at least one processor. The at least one processor is configured to execute instructions to: receive, from a user interface, a request to complete a computer implemented task; determine whether to send the request to a first computer system or a second, cloud-based computer system, the determination based on (i) an estimated hardware requirement necessary to the complete the computer implemented task, (ii) a latency requirement of the computer implemented task, (iii) a hardware capacity of the first computer system, and (iv) an estimated financial cost of using the second, cloud-based computer system for the computer implemented task; and send the request to complete the computer implemented task to either the first computer system or the second, cloud-based computer system based on the determination; wherein the computer implemented task is a Machine Learning (ML) task; wherein the estimated hardware requirement includes: central processing unit (CPU) requirements, graphical processing unit (GPU) requirements, memory requirements, storage requirements, and information download requirements; wherein the request to complete a computer implemented task from a user interface is initiated by a user; wherein the processor is further configured to, prior to receiving the request to complete a computer implemented task: receive a request from the user interface for logon access to the system, and authenticate the user; wherein a first token is required to access the first computer system and a second token is required to access the second, cloud-based computer system; wherein the processor is further configured to: automatically obtain and use the first token if the processor determines to send the request to the first computer system, and automatically obtain and use the second token if the processor determines to send the request to the second, cloud-based computer system.

Other systems, methods, and computer-readable media are also discussed herein.

### BRIEF DESCRIPTION OF THE DRAWINGS

FIG. 1A is a schematic block diagram illustrating an exemplary embodiment of a network comprising computerized systems for communications enabling shipping, transportation, and logistics operations, consistent with the disclosed embodiments.

FIG. 1B depicts a sample Search Result Page (SRP) that includes one or more search results satisfying a search request along with interactive user interface elements, consistent with the disclosed embodiments.

FIG. 1C depicts a sample Single Detail Page (SDP) that includes a product and information about the product along with interactive user interface elements, consistent with the disclosed embodiments.

FIG. 1D depicts a sample Cart page that includes items in a virtual shopping cart along with interactive user interface elements, consistent with the disclosed embodiments.

FIG. 1E depicts a sample Order page that includes items from the virtual shopping cart along with information regarding purchase and shipping, along with interactive user interface elements, consistent with the disclosed embodiments.

FIG. 2 is a diagrammatic illustration of an exemplary fulfillment center configured to utilize disclosed computerized systems, consistent with the disclosed embodiments.

FIG. 3 is a schematic block diagram illustrating an exemplary embodiment of a network comprising computerized systems for communications enabling optimization of computer implemented tasks, consistent with the disclosed embodiments.

FIG. 4 is a flowchart illustrating an exemplary embodiment of a method for optimizing computer implemented tasks, consistent with the disclosed embodiments.

### DETAILED DESCRIPTION

The following detailed description refers to the accompanying drawings. Wherever possible, the same reference numbers are used in the drawings and the following description to refer to the same or similar parts. While several illustrative embodiments are described herein, modifications, adaptations and other implementations are possible. For example, substitutions, additions, or modifications may be made to the components and steps illustrated in the drawings, and the illustrative methods described herein may be modified by substituting, reordering, removing, or adding steps to the disclosed methods. Accordingly, the following detailed description is not limited to the disclosed embodiments and examples. Instead, the proper scope of the invention is defined by the appended claims.

Embodiments of the present disclosure are directed to systems and methods configured for targeted advertising to a customer.

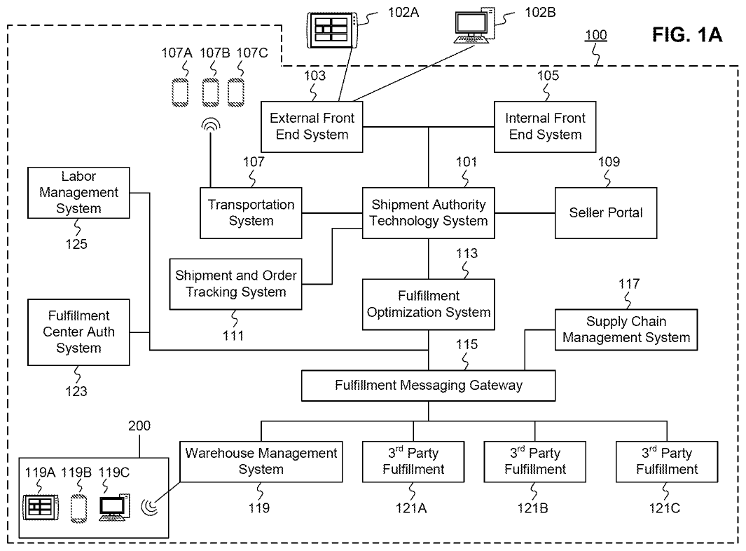

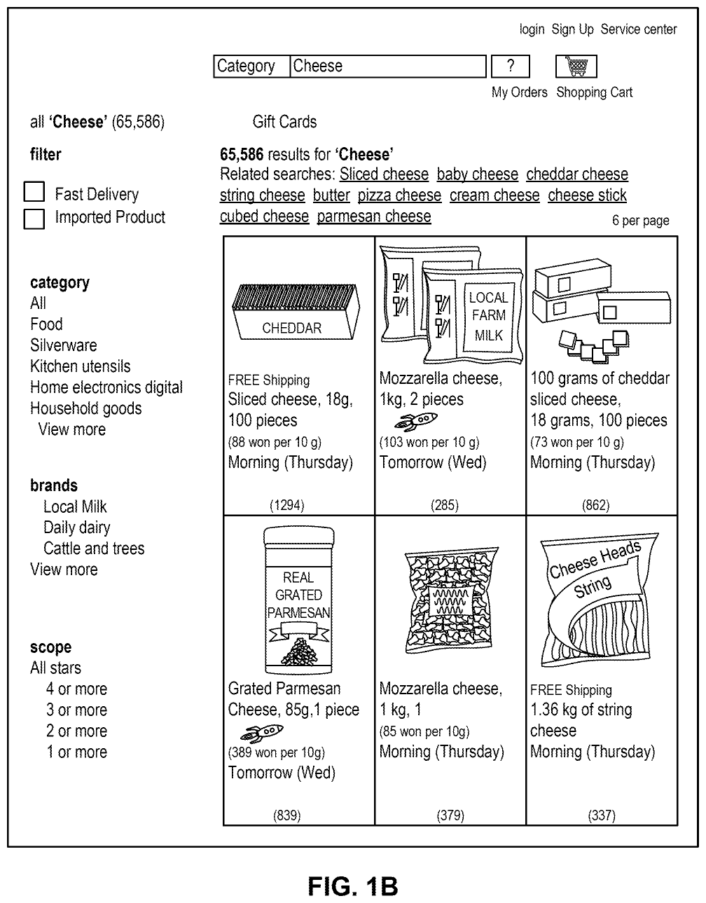

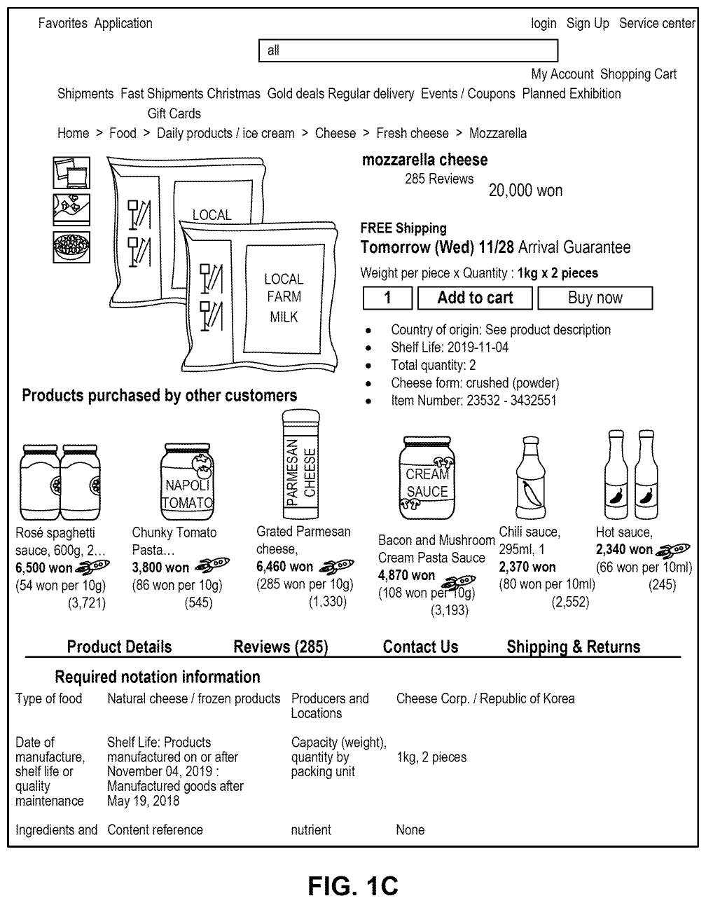

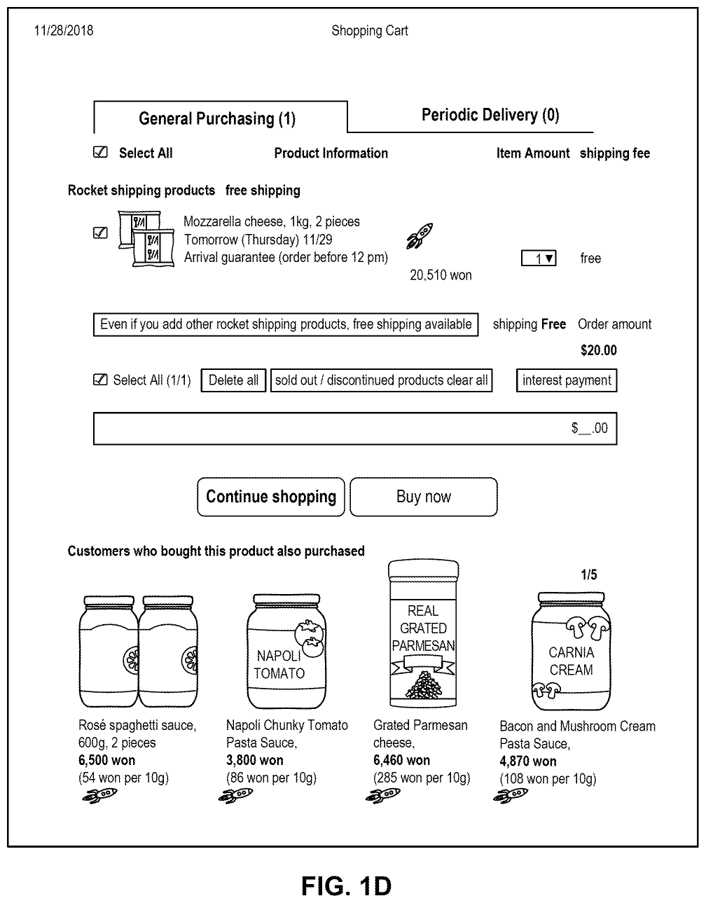

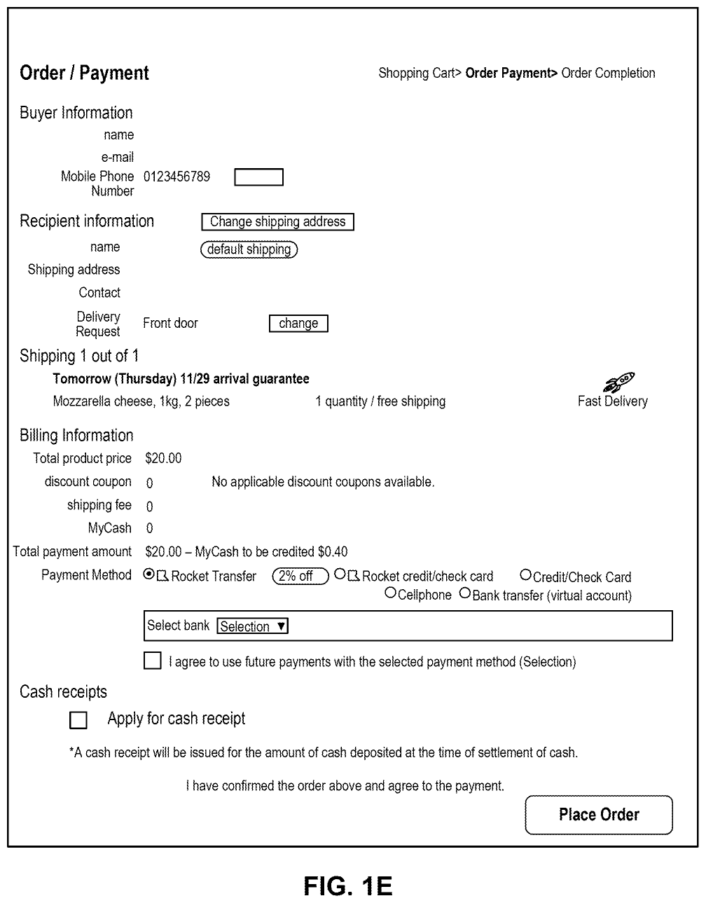

Referring to FIG. 1A, a schematic block diagram 100 illustrating an exemplary embodiment of a system comprising computerized systems for communications enabling shipping, transportation, and logistics operations is shown. As illustrated in FIG. 1A, system 100 may include a variety of systems, each of which may be connected to one another via one or more networks. The systems may also be connected to one another via a direct connection, for example, using a cable. The depicted systems include a shipment authority technology (SAT) system 101, an external front end system 103, an internal front end system 105, a transportation system 107, mobile devices 107A, 107B, and 107C, seller portal 109, shipment and order tracking (SOT) system 111, fulfillment optimization (FO) system 113, fulfillment messaging gateway (FMG) 115, supply chain management (SCM) system 117, warehouse management system 119, mobile devices 119A, 119B, and 119C (depicted as being inside of fulfillment center (FC) 200), 3^{rd} party fulfillment systems 121A, 121B, and 121C, fulfillment center authorization system (FC Auth) 123, and labor management system (LMS) 125.

SAT system 101, in some embodiments, may be implemented as a computer system that monitors order status and delivery status. For example, SAT system 101 may determine whether an order is past its Promised Delivery Date (PDD) and may take appropriate action, including initiating a new order, reshipping the items in the non-delivered order, canceling the non-delivered order, initiating contact with the ordering customer, or the like. SAT system 101 may also monitor other data, including output (such as a number of packages shipped during a particular time period) and input (such as the number of empty cardboard boxes received for use in shipping). SAT system 101 may also act as a gateway between different devices in system 100, enabling communication (e.g., using store-and-forward or other techniques) between devices such as external front end system 103 and FO system 113.

External front end system 103, in some embodiments, may be implemented as a computer system that enables external users to interact with one or more systems in system 100. For example, in embodiments where system 100 enables the presentation of systems to enable users to place an order for an item, external front end system 103 may be implemented as a web server that receives search requests, presents item pages, and solicits payment information. For example, external front end system 103 may be implemented as a computer or computers running software such as the Apache HTTP Server, Microsoft Internet Information Services (IIS), NGINX, or the like. In other embodiments, external front end system 103 may run custom web server software designed to receive and process requests from external devices (e.g., mobile device 102A or computer 102B), acquire information from databases and other data stores based on those requests, and provide responses to the received requests based on acquired information.

In some embodiments, external front end system 103 may include one or more of a web caching system, a database, a search system, or a payment system. In one aspect, external front end system 103 may comprise one or more of these systems, while in another aspect, external front end system 103 may comprise interfaces (e.g., server-to-server, database-to-database, or other network connections) connected to one or more of these systems.

An illustrative set of steps, illustrated by FIGS. 1B, 1C, 1D, and 1E, will help to describe some operations of external front end system 103. External front end system 103 may receive information from systems or devices in system 100 for presentation and/or display. For example, external front end system 103 may host or provide one or more web pages, including a Search Result Page (SRP) (e.g., FIG. 1B), a Single Detail Page (SDP) (e.g., FIG. 1C), a Cart page (e.g., FIG. 1D), or an Order page (e.g., FIG. 1E). A user device (e.g., using mobile device 102A or computer 102B) may navigate to external front end system 103 and request a search by entering information into a search box. External front end system 103 may request information from one or more systems in system 100. For example, external front end system 103 may request information from FO System 113 that satisfies the search request. External front end system 103 may also request and receive (from FO System 113) a Promised Delivery Date or “PDD” for each product included in the search results. The PDD, in some embodiments, may represent an estimate of when a package containing the product will arrive at the user's desired location or a date by which the product is promised to be delivered at the user's desired location if ordered within a particular period of time, for example, by the end of the day (11:59 PM). (PDD is discussed further below with respect to FO System 113.)

External front end system 103 may prepare an SRP (e.g., FIG. 1B) based on the information. The SRP may include information that satisfies the search request. For example, this may include pictures of products that satisfy the search request. The SRP may also include respective prices for each product, or information relating to enhanced delivery options for each product, PDD, weight, size, offers, discounts, or the like. External front end system 103 may send the SRP to the requesting user device (e.g., via a network).

A user device may then select a product from the SRP, e.g., by clicking or tapping a user interface, or using another input device, to select a product represented on the SRP. The user device may formulate a request for information on the selected product and send it to external front end system 103. In response, external front end system 103 may request information related to the selected product. For example, the information may include additional information beyond that presented for a product on the respective SRP. This could include, for example, shelf life, country of origin, weight, size, number of items in package, handling instructions, or other information about the product. The information could also include recommendations for similar products (based on, for example, big data and/or machine learning analysis of customers who bought this product and at least one other product), answers to frequently asked questions, reviews from customers, manufacturer information, pictures, or the like.

External front end system 103 may prepare an SDP (Single Detail Page) (e.g., FIG. 1C) based on the received product information. The SDP may also include other interactive elements such as a “Buy Now” button, a “Add to Cart” button, a quantity field, a picture of the item, or the like. The SDP may further include a list of sellers that offer the product. The list may be ordered based on the price each seller offers such that the seller that offers to sell the product at the lowest price may be listed at the top. The list may also be ordered based on the seller ranking such that the highest ranked seller may be listed at the top. The seller ranking may be formulated based on multiple factors, including, for example, the seller's past track record of meeting a promised PDD. External front end system 103 may deliver the SDP to the requesting user device (e.g., via a network).

The requesting user device may receive the SDP which lists the product information. Upon receiving the SDP, the user device may then interact with the SDP. For example, a user of the requesting user device may click or otherwise interact with a “Place in Cart” button on the SDP. This adds the product to a shopping cart associated with the user. The user device may transmit this request to add the product to the shopping cart to external front end system 103.

External front end system 103 may generate a Cart page (e.g., FIG. 1D). The Cart page, in some embodiments, lists the products that the user has added to a virtual “shopping cart.” A user device may request the Cart page by clicking on or otherwise interacting with an icon on the SRP, SDP, or other pages. The Cart page may, in some embodiments, list all products that the user has added to the shopping cart, as well as information about the products in the cart such as a quantity of each product, a price for each product per item, a price for each product based on an associated quantity, information regarding PDD, a delivery method, a shipping cost, user interface elements for modifying the products in the shopping cart (e.g., deletion or modification of a quantity), options for ordering other product or setting up periodic delivery of products, options for setting up interest payments, user interface elements for proceeding to purchase, or the like. A user at a user device may click on or otherwise interact with a user interface element (e.g., a button that reads “Buy Now”) to initiate the purchase of the product in the shopping cart. Upon doing so, the user device may transmit this request to initiate the purchase to external front end system 103.

External front end system 103 may generate an Order page (e.g., FIG. 1E) in response to receiving the request to initiate a purchase. The Order page, in some embodiments, re-lists the items from the shopping cart and requests input of payment and shipping information. For example, the Order page may include a section requesting information about the purchaser of the items in the shopping cart (e.g., name, address, e-mail address, phone number), information about the recipient (e.g., name, address, phone number, delivery information), shipping information (e.g., speed/method of delivery and/or pickup), payment information (e.g., credit card, bank transfer, check, stored credit), user interface elements to request a cash receipt (e.g., for tax purposes), or the like. External front end system 103 may send the Order page to the user device.

The user device may enter information on the Order page and click or otherwise interact with a user interface element that sends the information to external front end system 103. From there, external front end system 103 may send the information to different systems in system 100 to enable the creation and processing of a new order with the products in the shopping cart.

In some embodiments, external front end system 103 may be further configured to enable sellers to transmit and receive information relating to orders.

Internal front end system 105, in some embodiments, may be implemented as a computer system that enables internal users (e.g., employees of an organization that owns, operates, or leases system 100) to interact with one or more systems in system 100. For example, in embodiments where system 100 enables the presentation of systems to enable users to place an order for an item, internal front end system 105 may be implemented as a web server that enables internal users to view diagnostic and statistical information about orders, modify item information, or review statistics relating to orders. For example, internal front end system 105 may be implemented as a computer or computers running software such as the Apache HTTP Server, Microsoft Internet Information Services (IIS), NGINX, or the like. In other embodiments, internal front end system 105 may run custom web server software designed to receive and process requests from systems or devices depicted in system 100 (as well as other devices not depicted), acquire information from databases and other data stores based on those requests, and provide responses to the received requests based on acquired information.

In some embodiments, internal front end system 105 may include one or more of a web caching system, a database, a search system, a payment system, an analytics system, an order monitoring system, or the like. In one aspect, internal front end system 105 may comprise one or more of these systems, while in another aspect, internal front end system 105 may comprise interfaces (e.g., server-to-server, database-to-database, or other network connections) connected to one or more of these systems.

Transportation system 107, in some embodiments, may be implemented as a computer system that enables communication between systems or devices in system 100 and mobile devices 107A-107C. Transportation system 107, in some embodiments, may receive information from one or more mobile devices 107A-107C (e.g., mobile phones, smart phones, PDAs, or the like). For example, in some embodiments, mobile devices 107A-107C may comprise devices operated by delivery workers. The delivery workers, who may be permanent, temporary, or shift employees, may utilize mobile devices 107A-107C to effect delivery of packages containing the products ordered by users. For example, to deliver a package, the delivery worker may receive a notification on a mobile device indicating which package to deliver and where to deliver it. Upon arriving at the delivery location, the delivery worker may locate the package (e.g., in the back of a truck or in a crate of packages), scan or otherwise capture data associated with an identifier on the package (e.g., a barcode, an image, a text string, an RFID tag, or the like) using the mobile device, and deliver the package (e.g., by leaving it at a front door, leaving it with a security guard, handing it to the recipient, or the like). In some embodiments, the delivery worker may capture photo(s) of the package and/or may obtain a signature using the mobile device. The mobile device may send information to transportation system 107 including information about the delivery, including, for example, time, date, GPS location, photo(s), an identifier associated with the delivery worker, an identifier associated with the mobile device, or the like. Transportation system 107 may store this information in a database (not pictured) for access by other systems in system 100. Transportation system 107 may, in some embodiments, use this information to prepare and send tracking data to other systems indicating the location of a particular package.

In some embodiments, certain users may use one kind of mobile device (e.g., permanent workers may use a specialized PDA with custom hardware such as a barcode scanner, stylus, and other devices) while other users may use other kinds of mobile devices (e.g., temporary or shift workers may utilize off-the-shelf mobile phones and/or smartphones).

In some embodiments, transportation system 107 may associate a user with each device. For example, transportation system 107 may store an association between a user (represented by, e.g., a user identifier, an employee identifier, or a phone number) and a mobile device (represented by, e.g., an International Mobile Equipment Identity (IMEI), an International Mobile Subscription Identifier (IMSI), a phone number, a Universal Unique Identifier (UUID), or a Globally Unique Identifier (GUID)). Transportation system 107 may use this association in conjunction with data received on deliveries to analyze data stored in the database in order to determine, among other things, a location of the worker, an efficiency of the worker, or a speed of the worker.

Seller portal 109, in some embodiments, may be implemented as a computer system that enables sellers or other external entities to electronically communicate with one or more systems in system 100. For example, a seller may utilize a computer system (not pictured) to upload or provide product information, order information, contact information, or the like, for products that the seller wishes to sell through system 100 using seller portal 109.

Shipment and order tracking system 111, in some embodiments, may be implemented as a computer system that receives, stores, and forwards information regarding the location of packages containing products ordered by customers (e.g., by a user using devices 102A-102B). In some embodiments, shipment and order tracking system 111 may request or store information from web servers (not pictured) operated by shipping companies that deliver packages containing products ordered by customers.

In some embodiments, shipment and order tracking system 111 may request and store information from systems depicted in system 100. For example, shipment and order tracking system 111 may request information from transportation system 107. As discussed above, transportation system 107 may receive information from one or more mobile devices 107A-107C (e.g., mobile phones, smart phones, PDAs, or the like) that are associated with one or more of a user (e.g., a delivery worker) or a vehicle (e.g., a delivery truck). In some embodiments, shipment and order tracking system 111 may also request information from warehouse management system (WMS) 119 to determine the location of individual products inside of a fulfillment center (e.g., fulfillment center 200). Shipment and order tracking system 111 may request data from one or more of transportation system 107 or WMS 119, process it, and present it to a device (e.g., user devices 102A and 102B) upon request.

Fulfillment optimization (FO) system 113, in some embodiments, may be implemented as a computer system that stores information for customer orders from other systems (e.g., external front end system 103 and/or shipment and order tracking system 111). FO system 113 may also store information describing where particular items are held or stored. For example, certain items may be stored only in one fulfillment center, while certain other items may be stored in multiple fulfillment centers. In still other embodiments, certain fulfilment centers may be designed to store only a particular set of items (e.g., fresh produce or frozen products). FO system 113 stores this information as well as associated information (e.g., quantity, size, date of receipt, expiration date, etc.).

FO system 113 may also calculate a corresponding PDD (promised delivery date) for each product. The PDD, in some embodiments, may be based on one or more factors. For example, FO system 113 may calculate a PDD for a product based on a past demand for a product (e.g., how many times that product was ordered during a period of time), an expected demand for a product (e.g., how many customers are forecast to order the product during an upcoming period of time), a network-wide past demand indicating how many products were ordered during a period of time, a network-wide expected demand indicating how many products are expected to be ordered during an upcoming period of time, one or more counts of the product stored in each fulfillment center 200, which fulfillment center stores each product, expected or current orders for that product, or the like.

In some embodiments, FO system 113 may determine a PDD for each product on a periodic basis (e.g., hourly) and store it in a database for retrieval or sending to other systems (e.g., external front end system 103, SAT system 101, shipment and order tracking system 111). In other embodiments, FO system 113 may receive electronic requests from one or more systems (e.g., external front end system 103, SAT system 101, shipment and order tracking system 111) and calculate the PDD on demand.

Fulfilment messaging gateway (FMG) 115, in some embodiments, may be implemented as a computer system that receives a request or response in one format or protocol from one or more systems in system 100, such as FO system 113, converts it to another format or protocol, and forward it in the converted format or protocol to other systems, such as WMS 119 or 3^{rd} party fulfillment systems 121A, 121B, or 121C, and vice versa.

Supply chain management (SCM) system 117, in some embodiments, may be implemented as a computer system that performs forecasting functions. For example, SCM system 117 may forecast a level of demand for a particular product based on, for example, based on a past demand for products, an expected demand for a product, a network-wide past demand, a network-wide expected demand, a count of products stored in each fulfillment center 200, expected or current orders for each product, or the like. In response to this forecasted level and the amount of each product across all fulfillment centers, SCM system 117 may generate one or more purchase orders to purchase and stock a sufficient quantity to satisfy the forecasted demand for a particular product.

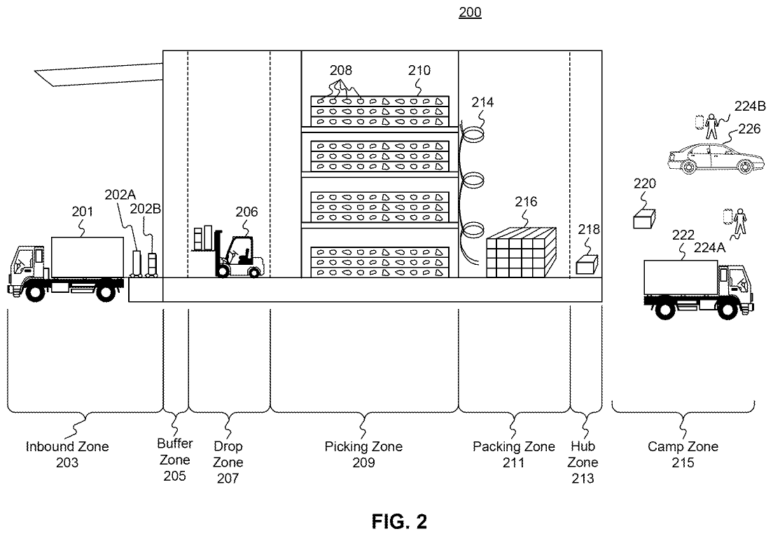

Warehouse management system (WMS) 119, in some embodiments, may be implemented as a computer system that monitors workflow. For example, WMS 119 may receive event data from individual devices (e.g., devices 107A-107C or 119A-119C) indicating discrete events. For example, WMS 119 may receive event data indicating the use of one of these devices to scan a package. As discussed below with respect to fulfillment center 200 and FIG. 2, during the fulfillment process, a package identifier (e.g., a barcode or RFID tag data) may be scanned or read by machines at particular stages (e.g., automated or handheld barcode scanners, RFID readers, high-speed cameras, devices such as tablet 119A, mobile device/PDA 1196, computer 119C, or the like). WMS 119 may store each event indicating a scan or a read of a package identifier in a corresponding database (not pictured) along with the package identifier, a time, date, location, user identifier, or other information, and may provide this information to other systems (e.g., shipment and order tracking system 111).

WMS 119, in some embodiments, may store information associating one or more devices (e.g., devices 107A-107C or 119A-119C) with one or more users associated with system 100. For example, in some situations, a user (such as a part- or full-time employee) may be associated with a mobile device in that the user owns the mobile device (e.g., the mobile device is a smartphone). In other situations, a user may be associated with a mobile device in that the user is temporarily in custody of the mobile device (e.g., the user checked the mobile device out at the start of the day, will use it during the day, and will return it at the end of the day).

WMS 119, in some embodiments, may maintain a work log for each user associated with system 100. For example, WMS 119 may store information associated with each employee, including any assigned processes (e.g., unloading trucks, picking items from a pick zone, rebin wall work, packing items), a user identifier, a location (e.g., a floor or zone in a fulfillment center 200), a number of units moved through the system by the employee (e.g., number of items picked, number of items packed), an identifier associated with a device (e.g., devices 119A-119C), or the like. In some embodiments, WMS 119 may receive check-in and check-out information from a timekeeping system, such as a timekeeping system operated on a device 119A-119C.

3^{rd} party fulfillment (3PL) systems 121A-121C, in some embodiments, represent computer systems associated with third-party providers of logistics and products. For example, while some products are stored in fulfillment center 200 (as discussed below with respect to FIG. 2), other products may be stored off-site, may be produced on demand, or may be otherwise unavailable for storage in fulfillment center 200. 3PL systems 121A-121C may be configured to receive orders from FO system 113 (e.g., through FMG 115) and may provide products and/or services (e.g., delivery or installation) to customers directly. In some embodiments, one or more of 3PL systems 121A-121C may be part of system 100, while in other embodiments, one or more of 3PL systems 121A-121C may be outside of system 100 (e.g., owned or operated by a third-party provider).

Fulfillment Center Auth system (FC Auth) 123, in some embodiments, may be implemented as a computer system with a variety of functions. For example, in some embodiments, FC Auth 123 may act as a single-sign on (SSO) service for one or more other systems in system 100. For example, FC Auth 123 may enable a user to log in via internal front end system 105, determine that the user has similar privileges to access resources at shipment and order tracking system 111, and enable the user to access those privileges without requiring a second log in process. FC Auth 123, in other embodiments, may enable users (e.g., employees) to associate themselves with a particular task. For example, some employees may not have an electronic device (such as devices 119A-119C) and may instead move from task to task, and zone to zone, within a fulfillment center 200, during the course of a day. FC Auth 123 may be configured to enable those employees to indicate what task they are performing and what zone they are in at different times of day.

Labor management system (LMS) 125, in some embodiments, may be implemented as a computer system that stores attendance and overtime information for employees (including full-time and part-time employees). For example, LMS 125 may receive information from FC Auth 123, WMS 119, devices 119A-119C, transportation system 107, and/or devices 107A-107C.

The particular configuration depicted in FIG. 1A is an example only. For example, while FIG. 1A depicts FC Auth system 123 connected to FO system 113, not all embodiments require this particular configuration. Indeed, in some embodiments, the systems in system 100 may be connected to one another through one or more public or private networks, including the Internet, an Intranet, a WAN (Wide-Area Network), a MAN (Metropolitan-Area Network), a wireless network compliant with the IEEE 802.11a/b/g/n Standards, a leased line, or the like. In some embodiments, one or more of the systems in system 100 may be implemented as one or more virtual servers implemented at a data center, server farm, or the like.

FIG. 2 depicts a fulfillment center 200. Fulfillment center 200 is an example of a physical location that stores items for shipping to customers when ordered. Fulfillment center (FC) 200 may be divided into multiple zones, each of which are depicted in FIG. 2. These “zones,” in some embodiments, may be thought of as virtual divisions between different stages of a process of receiving items, storing the items, retrieving the items, and shipping the items. So while the “zones” are depicted in FIG. 2, other divisions of zones are possible, and the zones in FIG. 2 may be omitted, duplicated, or modified in some embodiments.

Inbound zone 203 represents an area of FC 200 where items are received from sellers who wish to sell products using system 100 from FIG. 1A. For example, a seller may deliver items 202A and 202B using truck 201. Item 202A may represent a single item large enough to occupy its own shipping pallet, while item 202B may represent a set of items that are stacked together on the same pallet to save space.

A worker will receive the items in inbound zone 203 and may optionally check the items for damage and correctness using a computer system (not pictured). For example, the worker may use a computer system to compare the quantity of items 202A and 202B to an ordered quantity of items. If the quantity does not match, that worker may refuse one or more of items 202A or 202B. If the quantity does match, the worker may move those items (using, e.g., a dolly, a handtruck, a forklift, or manually) to buffer zone 205. Buffer zone 205 may be a temporary storage area for items that are not currently needed in the picking zone, for example, because there is a high enough quantity of that item in the picking zone to satisfy forecasted demand. In some embodiments, forklifts 206 operate to move items around buffer zone 205 and between inbound zone 203 and drop zone 207. If there is a need for items 202A or 202B in the picking zone (e.g., because of forecasted demand), a forklift may move items 202A or 202B to drop zone 207.

Drop zone 207 may be an area of FC 200 that stores items before they are moved to picking zone 209. A worker assigned to the picking task (a “picker”) may approach items 202A and 202B in the picking zone, scan a barcode for the picking zone, and scan barcodes associated with items 202A and 202B using a mobile device (e.g., device 119B). The picker may then take the item to picking zone 209 (e.g., by placing it on a cart or carrying it).

Picking zone 209 may be an area of FC 200 where items 208 are stored on storage units 210. In some embodiments, storage units 210 may comprise one or more of physical shelving, bookshelves, boxes, totes, refrigerators, freezers, cold stores, or the like. In some embodiments, picking zone 209 may be organized into multiple floors. In some embodiments, workers or machines may move items into picking zone 209 in multiple ways, including, for example, a forklift, an elevator, a conveyor belt, a cart, a handtruck, a dolly, an automated robot or device, or manually. For example, a picker may place items 202A and 202B on a handtruck or cart in drop zone 207 and walk items 202A and 202B to picking zone 209.

A picker may receive an instruction to place (or “stow”) the items in particular spots in picking zone 209, such as a particular space on a storage unit 210. For example, a picker may scan item 202A using a mobile device (e.g., device 119B). The device may indicate where the picker should stow item 202A, for example, using a system that indicate an aisle, shelf, and location. The device may then prompt the picker to scan a barcode at that location before stowing item 202A in that location. The device may send (e.g., via a wireless network) data to a computer system such as WMS 119 in FIG. 1A indicating that item 202A has been stowed at the location by the user using device 1196.

Once a user places an order, a picker may receive an instruction on device 1196 to retrieve one or more items 208 from storage unit 210. The picker may retrieve item 208, scan a barcode on item 208, and place it on transport mechanism 214. While transport mechanism 214 is represented as a slide, in some embodiments, transport mechanism may be implemented as one or more of a conveyor belt, an elevator, a cart, a forklift, a handtruck, a dolly, or the like. Item 208 may then arrive at packing zone 211.

Packing zone 211 may be an area of FC 200 where items are received from picking zone 209 and packed into boxes or bags for eventual shipping to customers. In packing zone 211, a worker assigned to receiving items (a “rebin worker”) will receive item 208 from picking zone 209 and determine what order it corresponds to. For example, the rebin worker may use a device, such as computer 119C, to scan a barcode on item 208. Computer 119C may indicate visually which order item 208 is associated with. This may include, for example, a space or “cell” on a wall 216 that corresponds to an order. Once the order is complete (e.g., because the cell contains all items for the order), the rebin worker may indicate to a packing worker (or “packer”) that the order is complete. The packer may retrieve the items from the cell and place them in a box or bag for shipping. The packer may then send the box or bag to a hub zone 213, e.g., via forklift, cart, dolly, handtruck, conveyor belt, manually, or otherwise.

Hub zone 213 may be an area of FC 200 that receives all boxes or bags (“packages”) from packing zone 211. Workers and/or machines in hub zone 213 may retrieve package 218 and determine which portion of a delivery area each package is intended to go to, and route the package to an appropriate camp zone 215. For example, if the delivery area has two smaller sub-areas, packages will go to one of two camp zones 215. In some embodiments, a worker or machine may scan a package (e.g., using one of devices 119A-119C) to determine its eventual destination. Routing the package to camp zone 215 may comprise, for example, determining a portion of a geographical area that the package is destined for (e.g., based on a postal code) and determining a camp zone 215 associated with the portion of the geographical area.

Camp zone 215, in some embodiments, may comprise one or more buildings, one or more physical spaces, or one or more areas, where packages are received from hub zone 213 for sorting into routes and/or sub-routes. In some embodiments, camp zone 215 is physically separate from FC 200 while in other embodiments camp zone 215 may form a part of FC 200.

Workers and/or machines in camp zone 215 may determine which route and/or sub-route a package 220 should be associated with, for example, based on a comparison of the destination to an existing route and/or sub-route, a calculation of workload for each route and/or sub-route, the time of day, a shipping method, the cost to ship the package 220, a PDD associated with the items in package 220, or the like. In some embodiments, a worker or machine may scan a package (e.g., using one of devices 119A-119C) to determine its eventual destination. Once package 220 is assigned to a particular route and/or sub-route, a worker and/or machine may move package 220 to be shipped. In exemplary FIG. 2, camp zone 215 includes a truck 222, a car 226, and delivery workers 224A and 224B. In some embodiments, truck 222 may be driven by delivery worker 224A, where delivery worker 224A is a full-time employee that delivers packages for FC 200 and truck 222 is owned, leased, or operated by the same company that owns, leases, or operates FC 200. In some embodiments, car 226 may be driven by delivery worker 224B, where delivery worker 224B is a “flex” or occasional worker that is delivering on an as-needed basis (e.g., seasonally). Car 226 may be owned, leased, or operated by delivery worker 224B.

As described above, E-commerce businesses may utilize computerized systems for communications enabling shipping, transportation, and logistics operations. These systems (e.g., system 100 as seen in FIG. 1A) require a variety of computer software applications that are designed and operated efficiently and effectively to maximize the shipping, transportation, and logistics operations. E-commerce businesses will often have to design and write these computer software applications to fit the specific needs of their businesses. Additionally, E-commerce businesses must process and store large amounts of data in the execution of these shipping, transportation, and logistics operations.

The efficacy of computer software applications to maximize shipping, transportation, and logistics operations may be improved with the use of machine learning (ML)/artificial intelligence (AI). For example, a computer software application that determines what route to use when delivering multiple packages may have to account for many variables (e.g., delivery locations, traffic conditions, fuel costs, idle times, etc.) in determining the best route to take for deliveries. E-commerce businesses may run computational experiments using ML/AI to find the best algorithms to use to optimize the efficacy of such a route determining software application. In another example, a computer software application that determines what promotions to offer customers may also have to account for many variables (purchase history, browsing history, future sale predictions, etc.) in matching customers with promotions that lead to the largest future revenues. E-commerce businesses may run computational experiments using ML/AI to find the best algorithms to use to optimize the efficacy of such a promotion choosing software application.

E-commerce business running of computational ML/AI experiments may do so using, for example, on-premises computer systems or off-premises cloud-based computer systems.

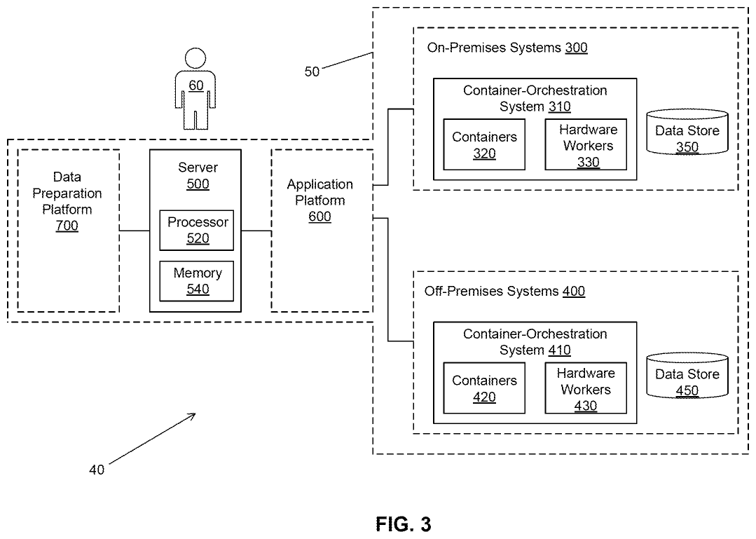

FIG. 3 is a schematic block diagram illustrating an exemplary embodiment of a network 40 comprising computerized systems optimizing and conducting computer implemented tasks, consistent with the disclosed embodiments. As seen in FIG. 3, the task optimization system 50 includes a server 500, an application platform 600, a data preparation platform 700, on-premises systems 300, and off-premises systems 400. While each of these systems is depicted in singular fashion, in some embodiments, one or more of these systems may be duplicated or omitted as the embodiments may require. For example, on-premises systems 300 may have a separate on-premises system 300a (not pictured) that is a backup of, a duplicate of, extra capacity for, or a failover system for, the systems in on-premises systems 300.

The basic components of server 500 include processor 520, and memory device 540, although server 300 may contain other components including those components that facilitate electronic communication. Other components may include user interface devices such as an input and output devices (not shown). Server 500 may include computer hardware components such as a combination of Central Processing Units (CPUs) or processors, buses, memory devices, storage units, data processors, input devices, output devices, network interface devices, and other types of components that are understood to those skilled in the art. Server 500 may further include application programs that may include software modules, sequences of instructions, routines, data structures, display interfaces, and other types of structures that execute operations of the present invention.

One of the hardware components in server 500 is processor 520. Processor 520 may be an ASIC (Application Specific Integrated Circuit) or it may be a general purpose processor. Processor 520 may include more than one processor. For example, processors may be situated in parallel, series, or both in order to process all or part of the computer instructions that are to be processed.

Memory device 540 may include all forms of computer-readable storage mediums such as non-volatile or volatile memories including, by way of example, semiconductor memory devices, such as EPROM, RAM, ROM, DRAM, EEPROM, and flash memory devices; magnetic disks such as internal hard disks and removable disks; magneto-optical disks; DVD disks, and CD-ROM disks. Memory device 540 may be used to store, for example, program code.

The server 500 is configured to interface and communicate with the application platform 600 and the data preparation platform 700. The application platform 600 is configured to send data to either the on-premises computer systems 300 (e.g., on-site servers) or the off-premises cloud-based computer systems 400 (e.g., Microsoft Azure, IBM SmartCloud, etc.).

In some embodiments, the components of systems 300 and 400 may be similar. This may be, for example, because tasks performable on the on-premises systems 300 ad the off-premises systems 400 may be similar in some ways (e.g., task type, calculations, storage requirements). For example, the on-premises systems 300 may include a container orchestration system 310 (e.g., Kubernetes) with a plurality of containers 320 and hardware workers 330 (e.g., GPU/CPU workers). The on-premises systems 300 may also include data repositories 350 (e.g., GlusterFS). Similarly, the off-premises systems 400 (e.g., Microsoft Azure, IBM SmartCloud, etc.) may include a container orchestration system 410 (e.g., Kubernetes) with a plurality of containers 420 and hardware workers 430 (e.g., GPU/CPU workers). The off-premises systems 400 may also include data repositories 450 (e.g., Data Lake).

A user interface of server 500 allows a user 60 wanting to execute a computer implemented task do so by logging onto the task optimization system 50. Example computer implemented tasks include ML/AI tasks and data storage tasks. These tasks may be associated with applications running on the application platform 600. Applications running on the application platform 600 include, but are not limited to, open-source program drafting tools (e.g., Jupyter Notebook), ML platforms (e.g., Polyaxon), storage APIs, etc. Given the computational/storage demands of the computer implemented tasks, the actual processing/storage associated with executing the computer implemented tasks must be done on more robust computer systems (e.g., the on-premises systems 300 or the off-premises systems 400). For a variety of reasons, it may be more desirable to run the computer implemented task on either the on-premises systems 300 or the off-premises systems 400.

Prior to running the computer implemented task on either the on-premises systems 300 or the off-premises systems 400, data necessary for executing the computer implemented task may need to be pre-processed or prepared prior to being implemented via the application platform 600. For example, for machine learning feature processing, multiple sources of data may need to be denormalized into a single source with data used for machine learning training. The data preparation platform 700 can utilize a variety of tools to pre-process or prepare the data. Example tools running on the data preparation platform include, but are not limited to, open-source applications for process streaming/analytics (e.g., Apache Kafka with Apache Spark), open-source data query and analysis (e.g., Apache Hive with Apache Spark), open source frameworks for distributed storage and processing (e.g., Apache Hadoop), and job/batch schedulers.

A task optimization module stored on the memory 540 and executed by the processor 520 automates the decision to and execution of running the computer implemented task on the on-premises systems 300 or the off-premises systems 400 without direction from the user. Accordingly, the task optimization module provides a level of abstraction that enables the user 60 to execute computer implemented tasks without concern for whether those tasks are being run locally or remotely.

In some embodiments, the task optimization module takes one or more factors into consideration when deciding between using the on-premises systems 300 or the off-premises systems 400. In some embodiments, the use on-premises systems 300 is preferable to the use of off-premises systems 400 due to their lower operating costs. Thus, in some embodiments, the task optimization module is programmed to utilize the on-premises systems 300 unless factors favor the use of off-premises systems 400.

In some embodiments, the task optimization module may make a determination between using the on-premises systems 300 or the off-premises systems 400 based on an estimated hardware requirement necessary to the complete the computer implemented task. This estimated hardware requirement may be based on user input of required resources for an experiment combined with a resource multiplication factor. Some tasks are specified by the user to be more GPU intensive while others are more CPU intensive. GPU infrastructure is comparatively expensive and more likely to have limited capacity in the on-premises systems 300. Thus, in many circumstances the task optimization module would favor sending a high GPU intensive task to the off-premises systems 400 because the on-premises system will not be capable of completing the task in an efficient manner. CPU infrastructure is comparatively inexpensive and more likely to have sufficient capacity in the on-premises systems 400. Thus, in many circumstances the task optimization module would favor sending a high CPU intensive task to the on-premises systems 300 because the off-premises systems 400 does not offer a significant efficiency boost.

In some embodiments, the task optimization module may make a determination between using the on-premises systems 300 or the off-premises systems 400 based on a latency requirement of the computer implemented task. Extensive travel distance for data results in delays between when an action is requested and when it is executed (i.e., latency). If data is stored locally, additional latency delays occur if that data needs to be uploaded to off-premises systems 400. Similarly, If data is stored remotely, additional latency delays occur if that data needs to be downloaded to on-premises systems 400. If large amounts of data are to be processed in the computer implemented task, the task optimization module will tend to favor the systems 300, 400 that are more proximal to the data to reduce inefficiencies due to latency. If smaller amounts of data are to be processed in the computer implemented task, the task optimization module will tend to favor the on-premises systems 300 since any inefficiencies due to latency will be less significant. In practice, for example, a user may indicate in the job specification if a job is Service Level Agreement (SLA) critical or not. Using this information, task optimization module may schedule SLA critical jobs immediately on off-premises systems 400 if required resources are not available on on-premises systems 300. For non-SLA critical jobs, task optimization module can schedule such jobs once resources are available on-premises.

In some embodiments, the task optimization module may make a determination between using the on-premises systems 300 or the off-premises systems 400 based on a hardware capacity of the on-premises computer systems 300. Sufficient hardware capacity may be determined, for example, by the system 100 checking current resource availability in on-premises clusters of the on-premises systems 300 by querying clusters resource utilization metrics. Using the current resource utilization metrics in on-premises systems 300, the system 100 may determine available capacity in on-premises systems 300 and verify if that available capacity meets the resource specification from user. Because on-premises computer systems 300 are not scalable on demand, any computer implemented task to be executed on the on-premises computer systems 300 are limited to using the hardware that is currently available. Thus, when hardware capacity (e.g., storage, GPU capacity, CPU capacity) of the on-premises computer systems 300 is low (either due to low amounts of physical hardware or high amounts of hardware that is already being used), the task optimization module will tend to favor off-premises computer systems 400 because the on-premises system will not be capable of completing the task in an efficient manner. Additionally, when hardware capacity (e.g., storage, GPU capacity, CPU capacity) of the on-premises computer systems 300 is higher (either due to high amounts of physical hardware or low amounts of hardware that is already being used), the task optimization module will tend to favor on-premises computer systems 300 because the off-premises systems 400 does not offer a significant efficiency boost.

In some embodiments, the task optimization module may make a determination between using the on-premises systems 300 or the off-premises systems 400 based on an estimated financial cost of using the off-premises computer systems 300 for the computer implemented task. Multiple factors go into the determining the financial cost of using off-premises systems 400. For example, larger jobs tend to be more expensive to run than smaller jobs. Additionally, heavy traffic within the off-premises systems 400 tend to raise the cost of accessing those systems 400. Additionally, contractual arrangements may stipulate that use of the off-premises systems 400 above a certain threshold will be charged at a higher rate than usage below that threshold. The task optimization module will use these cost determining factors to estimate the financial cost of a particular computer implemented task (e.g., with regards to the user specified hardware needs for CPU, memory, GPU, and data storage) on the off-premises systems 400, and the higher those estimated costs are, the more heavily the task optimization module will favor on-premises.

In some embodiments, the task optimization module will evaluate the above-described factors for determining between using the on-premises systems 300 or the off-premises systems 400 based on weighted averages and threshold requirements. For example, the task optimization module may weigh efficient operation of a task higher than the financial cost of running that task (or vice versa). Additionally, the relationship between hardware requirements of the task with respect to capacity of the on-premises systems 300 may end up being a threshold requirement regardless of the other factors. For example, if the on-premises systems 300 does not have sufficient hardware capacity to run the task, the task optimization module may choose the off-premises systems 400 regardless of what the other factors show.

As another example, the task optimization module may determine to use one system over another if it determines that any system (or any part of any system) is “unhealthy.” System health, in some embodiments, includes latency, disk storage, load, expected load, For example, task optimization module may consult a data store listing the health of each system (e.g., resource availability, ping/latency, processor load, or the like), or may determine the health of a system directly (e.g., by requesting such data from a system or using a “ping” to determine latency).

It is noted that computer implemented tasks may be made up of multiple subtasks. The task optimization module is, in some embodiments, configured to analyze each of the subtasks and determine whether each of the individual subtasks should be sent to the on-premises systems 300 or the off-premises systems 400 based the same factors described above. The task optimization module can analyze the subtasks individually (i.e., by determining the best destination for each subtask independently) or with relationship to each other (by taking into account the best destination for each subtask additionally based on where the other subtasks should go). This could result in additional efficiencies by, for example, having subtasks be run in parallel on different systems 300, 400.

By evaluating multiple factors prior to automatically determining the destination of the data associated with a computer implemented task, the task optimization module is able to increase the efficiency of executing the computer implemented task by picking the most suitable destination. This efficiency is achieved without having to burden users 60 with deciding the destination for themselves. Accordingly, by removing the user 60 from the decision process, additional time is saved, and additional efficiency is achieved.

Both on-premises systems 300 and off-premises systems 400 require authentication prior to allowing access. Authentication processes can be time consuming (e.g., 2-factor identification requires entering a unique password and entry of a supplemental code that is sent to a known device) and repetitive (when users require access to multiple systems, they often find themselves doing the same types of authentications multiple times).

The task optimization module further increases the efficiency of executing computer implemented tasks by allowing for a single authentication regardless of how many systems the task optimization module needs to access.

For example, when the user 60 logs on to the task optimization module on the server 500, the user may undergo a single instance of authentication (e.g., passwords, key cards, biometrics, etc.). Once the task optimization module confirms the identity of the user 60 (e.g., checking the validity of a password), the task optimization module may determine which team the user 60 is associated with (e.g., by reviewing a database stored at server 500, on-premises systems 300, or elsewhere). The task optimization module may retrieve all of the tokens required for accessing the on-premises systems 300 and off-premises systems 400 that the user's associated team is granted access to. For example, the task optimization module may retrieve a set of keys from a key storage system (e.g., HashiCorp Vault). The task optimization module may then access all of the on-premises systems 300 and off-premises systems 400 at once or access only the on-premises systems 300 and off-premises systems 400 that task optimization module decides to execute computer implemented tasks on.

Thus, by eliminating the need for multiple authentications, the task optimization module as able to achieve additional efficiency when executing computer implemented tasks.

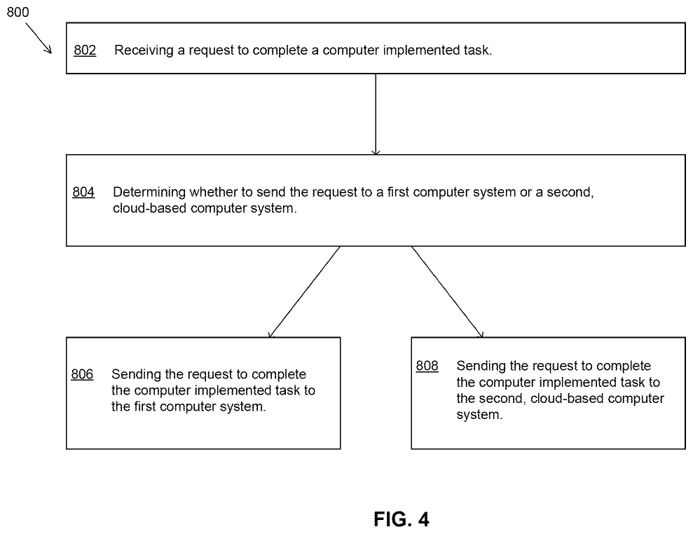

FIG. 4 is a flowchart illustrating an exemplary embodiment of method 800 for optimizing computer implemented tasks, consistent with the disclosed embodiments. The method begins with step 802.

Step 802 is receiving, at a server 500 from a user 60 interface, a request to complete a computer implemented task. As mentioned above, the computer implemented task may be, for example, a ML/AI experiment, data storage, etc.

Step 804 is determining whether to send the request to a first computer system 300 or a second, cloud-based computer system 400, the determination based on (i) an estimated hardware requirement necessary to the complete the computer implemented task, (ii) a latency requirement of the computer implemented task, (iii) a hardware capacity of the first computer system 300, and (iv) an estimated financial cost of using the second, cloud-based computer system 400 for the computer implemented task. The first computer system 300 can be an on-premises computer system 300 (e.g., on-site servers). The second, cloud-based computer system 400 can be an off-premises computer system 400 (e.g., Amazon Web Services).

Step 806 is sending the request to complete the computer implemented task to the first computer system 300 based on the determination. The processor 520 of the server 500 will generally make this decision if for example, the computer implemented task is CPU instead of GPU intensive, the data associated with the computer implemented task is proximal to the first computer system 300, the first computer system 300 has sufficient capacity to run the computer implemented task, or the cost of using the second, cloud-based computer system 400 is prohibitively high.

Step 808 is sending the request to complete the computer implemented task to the second, cloud-based computer system 400 based on the determination. The processor 520 of the server 500 will generally make this decision if for example, the computer implemented task is GPU instead of CPU intensive, the data associated with the computer implemented task is proximal to the second, cloud-based computer system 400, the first computer system 300 does not have sufficient capacity to run the computer implemented task, or the cost of using the second, cloud-based computer system 400 is relatively low.

While the present disclosure has been shown and described with reference to particular embodiments thereof, it will be understood that the present disclosure can be practiced, without modification, in other environments. The foregoing description has been presented for purposes of illustration. It is not exhaustive and is not limited to the precise forms or embodiments disclosed. Modifications and adaptations will be apparent to those skilled in the art from consideration of the specification and practice of the disclosed embodiments. Additionally, although aspects of the disclosed embodiments are described as being stored in memory, one skilled in the art will appreciate that these aspects can also be stored on other types of computer readable media, such as secondary storage devices, for example, hard disks or CD ROM, or other forms of RAM or ROM, USB media, DVD, Blu-ray, or other optical drive media.

Computer programs based on the written description and disclosed methods are within the skill of an experienced developer. Various programs or program modules can be created using any of the techniques known to one skilled in the art or can be designed in connection with existing software. For example, program sections or program modules can be designed in or by means of .Net Framework, .Net Compact Framework (and related languages, such as Visual Basic, C, etc.), Java, C++, Objective-C, HTML, HTML/AJAX combinations, XML, or HTML with included Java applets.

Moreover, while illustrative embodiments have been described herein, the scope of any and all embodiments having equivalent elements, modifications, omissions, combinations (e.g., of aspects across various embodiments), adaptations and/or alterations as would be appreciated by those skilled in the art based on the present disclosure. The limitations in the claims are to be interpreted broadly based on the language employed in the claims and not limited to examples described in the present specification or during the prosecution of the application. The examples are to be construed as non-exclusive. Furthermore, the steps of the disclosed methods may be modified in any manner, including by reordering steps and/or inserting or deleting steps. It is intended, therefore, that the specification and examples be considered as illustrative only, with a true scope and spirit being indicated by the following claims and their full scope of equivalents.

What is claimed is:

1. A computer-implemented system for optimizing computer implemented tasks comprising:
a processor configured to:
receive, from a user interface, a request to complete a computer implemented task;
determine whether to send the request to a first computer system or a second, cloud-based computer system, the determination based on (i) an estimated hardware requirement necessary to the complete the computer implemented task, (ii) a latency requirement of the computer implemented task, (iii) a hardware capacity of the first computer system, and (iv) an estimated financial cost of using the second, cloud-based computer system for the computer implemented task; and
send the request to complete the computer implemented task to either the first computer system or the second, cloud-based computer system based on the determination.

2. The computer-implemented system of claim 1, wherein the computer implemented task is a Machine Learning (ML) task.

3. The computer-implemented system of claim 1, wherein the estimated hardware requirement includes: central processing unit (CPU) requirements, graphical processing unit (GPU) requirements, memory requirements, storage requirements, and information download requirements.

4. The computer-implemented system of claim 1:
wherein the computer implemented task includes a plurality of subtasks; and
further wherein the processor is configured to:
determine whether to send the request to the first computer system or the second, cloud-based computer system includes being configured to determine whether to send each of the plurality of subtasks to the first computer system or the second, cloud-based computer system based on (i) an estimated hardware requirement necessary to the complete each of the plurality of subtasks, (ii) a latency requirement of each of the plurality of subtasks, (iii) the hardware capacity of the first computer system, and (iv) an estimated financial cost of using the second, cloud-based computer system for each of the plurality of subtasks; and
send the request to complete the computer implemented task to either the first computer system or the second, cloud-based computer system includes being configured to send each of the plurality of subtasks to either the first computer system or the second, cloud-based computer system based on the determination.

5. The computer-implemented system of claim 4 wherein the plurality of subtasks includes a data pre-processing task, and a machine learning (ML) training task.

6. The computer-implemented system of claim 1, wherein the processor is further configured to, prior to determining, verify that the first computer system and the second, cloud-based computer system are operational.

7. The computer-implemented system of claim 1:
wherein the request to complete a computer implemented task from a user interface is initiated by a user; and
wherein the processor is further configured to, prior to receiving the request to complete a computer implemented task:
receive a request from the user interface for logon access to the system, and
authenticate the user.

8. The computer-implemented system of claim 7, wherein the processor is further configured to, after authenticating the user, log the user on to both the first computer system and the second, cloud-based computer system regardless of the determination.

9. The computer-implemented system of claim 7:
wherein a first token is required to access the first computer system and a second token is required to access the second, cloud-based computer system;
wherein the processor is further configured to:
automatically obtain and use the first token if the processor determines to send the request to the first computer system, and
automatically obtain and use the second token if the processor determines to send the request to the second, cloud-based computer system.

10. The computer-implemented system of claim 9:
wherein the processor being configured to authenticate the user includes associating the user with a team of users;
wherein the first token and the second token are specific to the team which the user is associated with.

11. A computer-implemented method for optimizing computer implemented tasks comprising:
receiving, at a server from a user interface, a request to complete a computer implemented task;
determining whether to send the request to a first computer system or a second, cloud-based computer system, the determination based on (i) an estimated hardware requirement necessary to the complete the computer implemented task, (ii) a latency requirement of the computer implemented task, (iii) a hardware capacity of the first computer system, and (iv) an estimated financial cost of using the second, cloud-based computer system for the computer implemented task; and
sending the request to complete the computer implemented task to either the first computer system or the second, cloud-based computer system based on the determination.

12. The computer-implemented method of claim 11, wherein the computer implemented task is a Machine Learning (ML) task.

13. The computer-implemented method of claim 11, wherein the estimated hardware requirement includes: central processing unit (CPU) requirements, graphical processing unit (GPU) requirements, memory requirements, storage requirements, and information download requirements.

14. The computer-implemented method of claim 11:
wherein the computer implemented task includes a plurality of subtasks;
wherein the method further comprises:
determining whether to send the request to the first computer system or the second, cloud-based computer system includes being configured to determine whether to send each of the plurality of subtasks to the first computer system or the second, cloud-based computer system based on (i) an estimated hardware requirement necessary to the complete each of the plurality of subtasks, (ii) a latency requirement of each of the plurality of subtasks, (iii) the hardware capacity of the first computer system, and (iv) an estimated financial cost of using the second, cloud-based computer system for each of the plurality of subtasks; and
sending the request to complete the computer implemented task to either the first computer system or the second, cloud-based computer system includes being configured to send each of the plurality of subtasks to either the first computer system or the second, cloud-based computer system based on the determination.

15. The computer-implemented method of claim 14 wherein the plurality of subtasks includes a data pre-processing task, and a machine learning (ML) training task.

16. The computer-implemented method of claim 11, further comprising, prior to determining, verifying that the first computer system and the second, cloud-based computer system are operational.

17. The computer-implemented method of claim 11:
wherein the request to complete a computer implemented task from a user interface is initiated by a user; and
wherein the method further comprises, prior to receiving the request to complete a computer implemented task:
receiving a request from the user interface for logon access to the system, and
authenticating the user.

18. The computer-implemented method of claim 17, further comprising, after authenticating the user, log the user on to both the first computer system and the second, cloud-based computer system regardless of the determination.

19. The computer-implemented method of claim 17:
wherein a first token is required to access the first computer system and a second token is required to access the second, cloud-based computer system;
wherein the method further comprises:
automatically obtaining and use the first token if the processor determines to send the request to the first computer system, and
automatically obtaining and use the second token if the processor determines to send the request to the second, cloud-based computer system.

20. A computer-implemented system for optimizing computer implemented tasks comprising:
a memory storing instructions; and
at least one processor configured to execute the instructions to:
receive, from a user interface, a request to complete a computer implemented task;
determine whether to send the request to a first computer system or a second, cloud-based computer system, the determination based on (i) an estimated hardware requirement necessary to the complete the computer implemented task, (ii) a latency requirement of the computer implemented task, (iii) a hardware capacity of the first computer system, and (iv) an estimated financial cost of using the second, cloud-based computer system for the computer implemented task; and
send the request to complete the computer implemented task to either the first computer system or the second, cloud-based computer system based on the determination;
wherein the computer implemented task is a Machine Learning (ML) task;
wherein the estimated hardware requirement includes: central processing unit (CPU) requirements, graphical processing unit (GPU) requirements, memory requirements, storage requirements, and information download requirements;
wherein the request to complete a computer implemented task from a user interface is initiated by a user;
wherein the processor is further configured to, prior to receiving the request to complete a computer implemented task:
receive a request from the user interface for logon access to the system, and
authenticate the user;
wherein a first token is required to access the first computer system and a second token is required to access the second, cloud-based computer system;
wherein the processor is further configured to:
automatically obtain and use the first token if the processor determines to send the request to the first computer system, and
automatically obtain and use the second token if the processor determines to send the request to the second, cloud-based computer system.
